(19) United States
(12) Patent Application Publication
(10) Pub. No.: US 2014/0182448 A1
(43) Pub. Date: Jul. 3, 2014

(54) ARROW MOUNTED BLIND OR DECOY

(71) Applicant: James Jantzen, Del Norte, CO (US)

(72) Inventor: James Jantzen, Del Norte, CO (US)

(21) Appl. No.: 14/196,886

(22) Filed: Mar. 4, 2014

Related U.S. Application Data
(63) Continuation-in-part of application No. 13/566,968, filed on Aug. 3, 2012, now Pat. No. 8,720,428.

(51) Int. Cl. F41H 3/02; A01M 31/02

(52) U.S. Cl. CPC F41H 3/02; A01M 31/025
USPC 89/36.01; 29/428; 29/426.2

(57) ABSTRACT

An arrow mounted blind or decoy offers portability, flexibility, and minimum weight while always being mounted to a bow or gun. The arrow mounted blind or decoy can be quickly deployed and folded against the arrow to which it is affixed and stowed out of the way. A mount is attached to an arrow with clamp screws. Spars are attached to the mount with an internal shock cord that runs through the mount. In another embodiment, fabric having a camouflage or decoy pattern is mounted directly to an arrow and is rolled up tightly around the arrow and stowed in a bow quiver. The arrow is removed from the bow quiver and shot or driven into a tree. The fabric is unfurled from the bow and allowed to hang down, revealing the camouflage or decoy pattern, and giving the hunter freedom to move about the arrow mounted blind or decoy.

### CROSS-REFERENCES TO RELATED APPLICATIONS

This application is a continuation-in-part of application Ser. No. 13/566,968 Titled “Arrow Mounted Blind Or Decoy” filed on Aug. 3, 2012, which claims the benefit of U.S. Provisional Application Ser. No. 61/618,751 titled “Arrow Mounted Blind Or Decoy” filed on Mar. 31, 2012, both of which are incorporated herein by reference in their entirety for all that is taught and disclosed therein.

### BACKGROUND

This disclosure relates generally to bow hunting and more specifically to camouflage cover and decoys for bow hunters and the like.

### SUMMARY

This summary is provided to introduce in a simplified form a selection of concepts that are further described below in the detailed description. This summary is not intended to identify key features or essential features of the claimed subject matter, nor is it intended to be used to limit the scope of the claimed subject matter.

The detailed description below describes an arrow mounted blind or decoy that offers portability, flexibility, and minimum weight while always being mounted to a bow. The arrow mounted blind or decoy can be quickly deployed and easily folded against the arrow to which it is affixed and stowed out of the way in a quiver when not needed. A mount is attached to an arrow with clamp screws. Spars are attached to the mount with an internal shock cord that runs through the mount. Fabric having a camouflage or decoy pattern is attached to the spars. In a deployed position, a hole in the fabric allows the hunter to see through to observe game while concealing the hunter from the game. When the spars are folded the internal shock cord will stretch allowing the spars to be folded over and attached to the arrow with a spar clamp.

In another embodiment, fabric having a camouflage or decoy pattern is mounted directly to an arrow and is rolled up tightly around the arrow and stowed in a bow quiver. The arrow is removed from the bow quiver and shot or driven into a tree. The fabric is unfurled from the bow and allowed to hang down from the arrow, revealing the camouflage or decoy pattern, and giving the hunter freedom to move about in relation to the arrow mounted blind or decoy.

### BRIEF DESCRIPTION OF THE SEVERAL VIEWS OF THE DRAWINGS

FIG. 1 shows an elevation view of an embodiment of an arrow mounted blind or decoy in a deployed position attached to a bow of the present invention.

FIGS. 2A, 2B, and 2C show a front view, a top view, and a side view of the mount detail of an embodiment of an arrow mounted blind or decoy of the present invention.

FIG. 3 shows an elevation view of an embodiment of an arrow mounted blind or decoy in a folded position of the present invention.

FIG. 4 shows an elevation view of an embodiment of an arrow mounted blind or decoy attached to a tree of the present invention.

FIG. 5 shows a perspective view of another embodiment of an arrow mounted blind or decoy in a folded position of the present invention.

FIG. 6 shows a perspective view of an embodiment of an arrow mounted blind or decoy in a stowed position of the present invention.

FIG. 7 shows an elevation view of an embodiment of an arrow mounted blind or decoy attached to a tree of the present invention.

FIG. 8 shows a perspective view of an embodiment of an arrow mounted blind or decoy in a deployed position attached to a bow of the present invention.

FIG. 9 shows a detailed view of an embodiment of an arrow mounted blind or decoy in a mount of the present invention.

FIGS. 10A, 10B, and 10C show various views of another embodiment of a blind or decoy of the present invention.

To assist in the understanding of the present disclosure the following list of components and associated numbering found in the drawings is provided herein:

Table of Components

| Component | # |
|---|---|
| Bow | 1 |
| Bow | 1′ |
| Quiver | 2 |
| Quiver | 2′ |
| Mounting Brackets | 2B |
| Mounting Brackets | 2B′ |
| Mount | 3 |
| Mount | 3′ |
| Mount | 3″ |
| Clamp Screws | 3A |
| Clamp Screws | 3A′ |
| Clamp Screws | 3A″ |
| Arrow | 4 |
| Arrow | 4′ |
| Channel | 4A |
| Spars | 5 |
| Spars | 5′ |
| Spar Holes | 5A |
| Shoulders | 5B |
| Fabric | 6 |
| Fabric | 6′ |
| Fabric | 6″ |
| View Hole | 7 |
| Spar Clamp | 8 |
| Finger Tab | 9 |
| Internal Shock Cord | 10 |
| Strap | 11 |
| Tree | 12 |
| Tree | 12′ |
| Buckle | 13 |
| Angle Bracket | 14 |
| Hollow Receiving Member | 15 |
| Weights | 16 |
| Grommets | 17 |
| Hole | 18 |
| Cord | 19 |
| Stakes | 20 |
| Ground | 21 |
| Barrel | 22 |
| Barrel Mount | 23 |
| Attachment Rod | 24 |
| Stiffening Spars | 25 |
| Gun | 26 |
| Ties | 27 |
| Arrow Mounted Blind Or Decoy | 100 |
| Arrow Mounted Blind Or Decoy | 100′ |
| Arrow Mounted Blind Or Decoy | 100″ |

### DETAILED DESCRIPTION

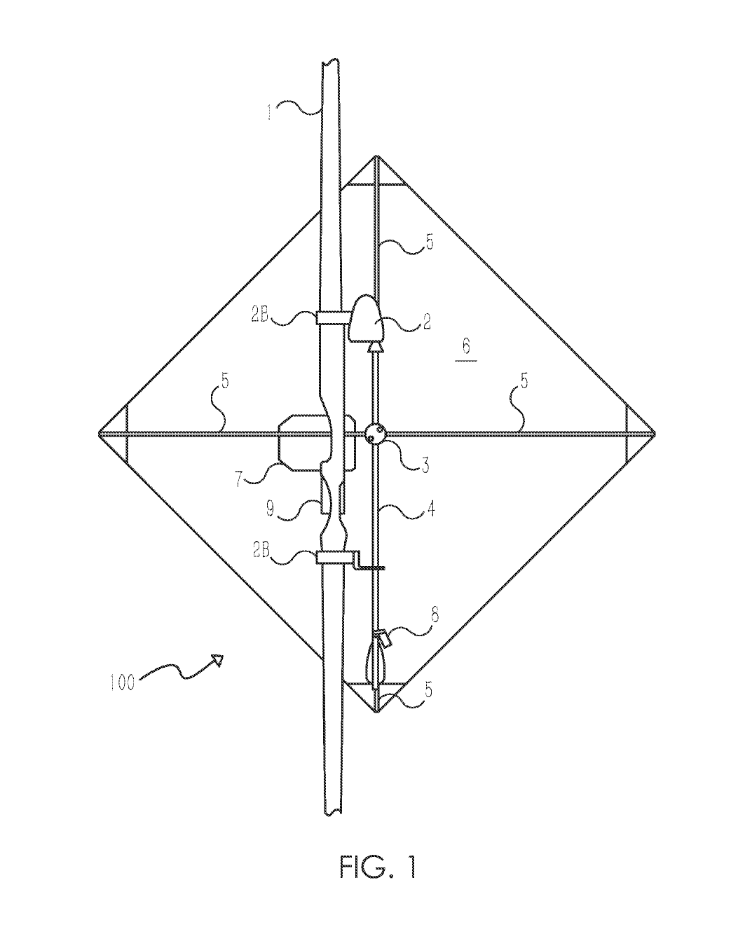

Referring now to the Figures, in which like reference numerals refer to structurally and/or functionally similar elements thereof, FIG. 1 shows an elevation view of an embodiment of an arrow mounted blind or decoy in a deployed position of the present invention. Referring now to FIG. 1, Arrow Mounted Blind Or Decoy 100 has the benefit of being light in weight and can be quickly mounted to Quiver 2 of Bow 1. Quiver 2 has two Mounting Brackets 2B to mount Quiver 2 to Bow 1. Thus, Arrow Mounted Blind Or Decoy 100 can be quickly deployed but also folded against Arrow 4 to which it is affixed and stowed out of the way in the bow-mounted Quiver 2. Arrow 4 of Arrow Mounted Blind Or Decoy 100 is typically stowed in the leading slot of Quiver 2 so that when it is deployed it will clear the front of Bow 1, offering concealment to the hunter, and allow easy access to the other arrows stowed in Quiver 2.

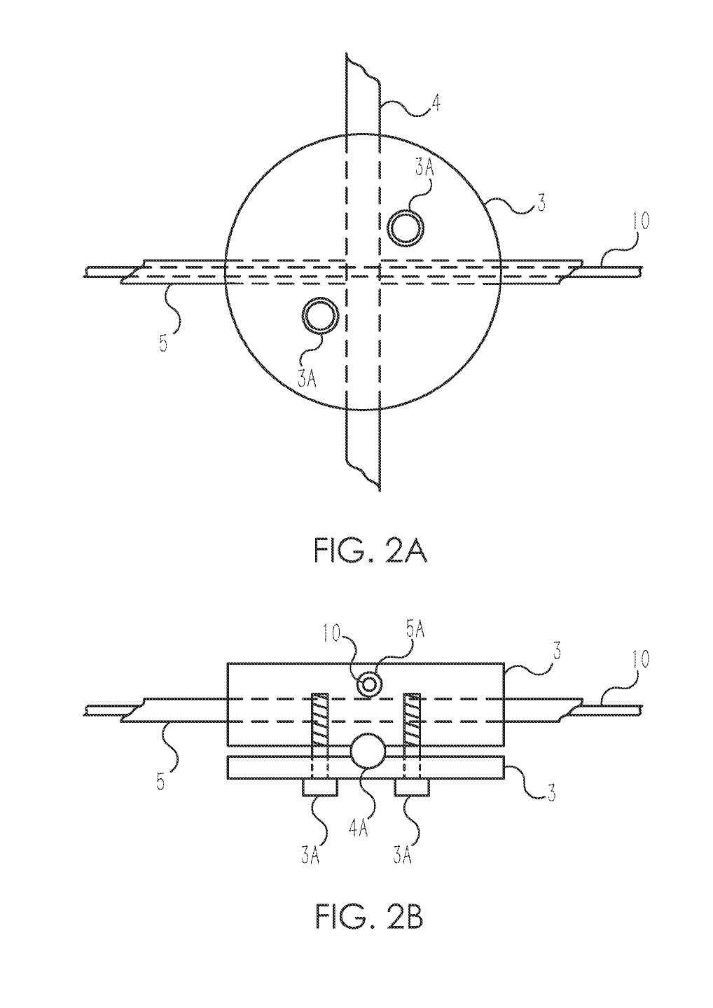

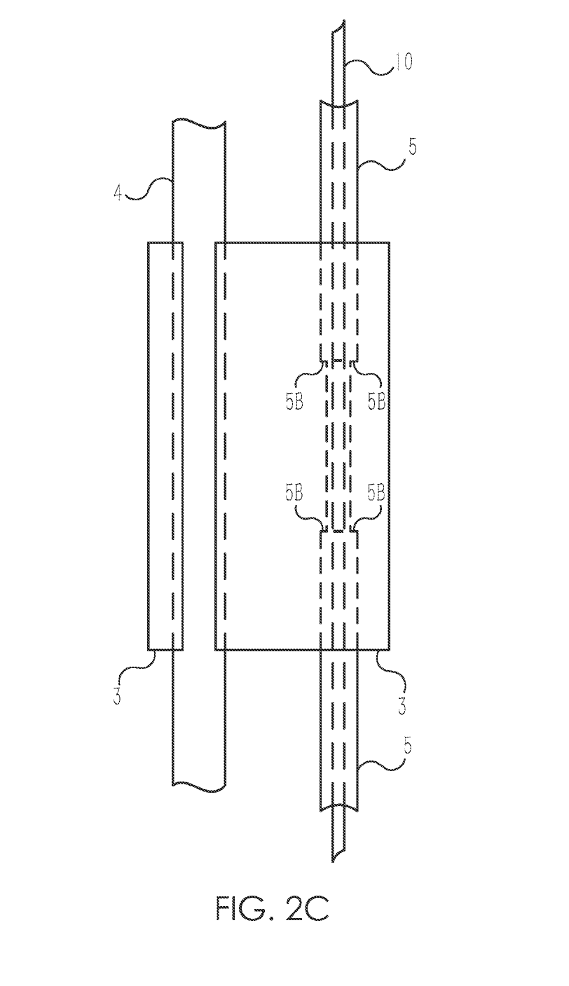

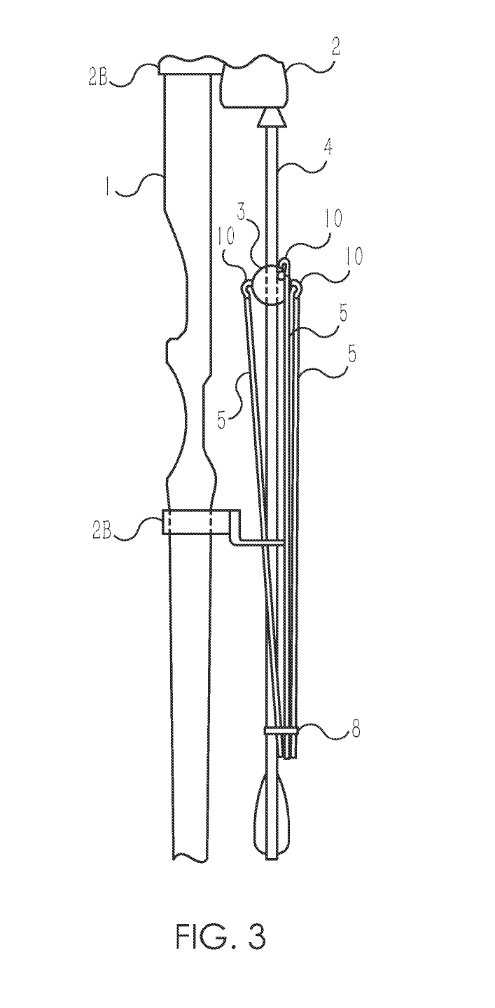

Mount 3 is attached to Arrow 4 with Clamp Screws 3A. In one embodiment Arrow 4 is a rod similar in length and diameter to an arrow. Channel 4A (see FIG. 2B) receives Arrow 4 between the two halves of Mount 3. When Clamp Screws 3A are tightened, the two halves of Mount 3 act like a clamp on Arrow 4. Mount 3 may be made of aluminum or any other suitable material. Fabric 6 is attached to Spars 5 which are hollow tubes or rods and may be made of carbon fiber or any other suitable material. Fabric 6 may have a variety of camouflage patterns and a variety of colors to match the terrain where used, or a decoy pattern of a game animal. Fabric 6 may be made of silk or any other appropriate material. Fabric 6 may also have reinforced corners that receive the ends of Spars 5. View Hole 7 located somewhat centrally in Fabric 6 allows the bow hunter to see through Fabric 6 and shoot at game. Thus, Mount 3 is attached to Arrow 4 with Clamp Screws 3A so that View Hole 7 is aligned to receive an arrow when drawn with Bow 1. Finger Tab 9 is attached to Fabric 6 so the hunter can place a finger through Finger Tab 9 while holding Bow 1 to hold Fabric 6 to Bow 1 in a way to minimize movement of Fabric 6. Quiver 2 is mounted to Bow 1 in any of several standard ways known by one skilled in the art. Arrow Mounted Blind Or Decoy 100 is stored folded in Quiver 2 (see FIG. 3) until needed. Mount 3 will universally mount to any standard arrow or an appropriately sized rod.

FIG. 2A shows a front view, FIG. 2B shows a top view, and FIG. 2C shows a side view of the mount detail of an embodiment of an arrow mounted blind or decoy of the present invention. Referring now to FIGS. 2A, 2B, and 2C, Spars 5 from the folded position are inserted into Mount 3 with Internal Shock Cord 10 running through Spars 5 and Mount 3. Internal Shock Cord 10 may be made of nylon elastic rope or any other suitable material. Mount 3 has Spar Holes 5A that are drilled or bored through Mount 3 letting Internal Shock Cord 10 run from one end of Spars 5 through Mount 3 to the other end of the opposing Spars 5. Spar Holes 5A are drilled or bored in Mount 3 in such a way that there are Shoulders 5B inside Mount 3 so Spars 5 can only enter about one-third of the way to less than one-half way into Mount 3. Spar Holes 5A are slightly larger than Spars 5 for easy removal, but allowing for a firm fit of Spars 5 in Spar Holes 5A. Spar Holes 5A through Mount 3 are big enough to allow Internal Shock Cord 10 easy movement so it can stretch allowing Spars 5 to be removed, folded, and stored.

FIG. 3 shows an elevation view of an embodiment of an arrow mounted blind or decoy in a folded position of the present invention. Referring now to FIG. 3, when Spars 5 are folded Internal Shock Cord 10 will stretch allowing Spars 5 to be folded over and attached to Arrow 4 with Spar Clamp 8. (Fabric 6 is not shown in FIG. 3 for clarity. Fabric 6 will fold and buckle similar to the fabric of a folded umbrella, or, Fabric 6 may be removed from Spars 5 and folded up and stored by the hunter when not needed.) A first Internal Shock Cord 10 is attached at a first end to an outer end of a first Spar 5, runs through Mount 3, and is attached at a second end to an outer end of a second Spar 5. A second Internal Shock Cord 10 is attached at a first end to an outer end of a third Spar 5, runs through Mount 3, and is attached at a second end to an outer end of a fourth Spar 5. The first and second Spars 5 with the first Internal Shock Cord 10, and the third and fourth Spars 5 with the second Internal Shock Cord 10 may be aligned straight, or at 90° to each other, when unfolded or deployed. The tension provided by Internal Shock Cords 10 will keep the inner ends of each Spar 5 seated in Mount 3 up to Shoulders 5B. Only one Internal Shock Cord 10 could be used by doubling back on itself through the Spars 5 provided that the internal diameter of Spars 5 and the Spar Holes 5A can accommodate two lengths of Internal Shock Cord 10 there through without restricting the stretching and contracting of Internal Shock Cord 10. Fabric 6 is attached at each corner to an outer end of each of the four Spars 5 and is sized to allow for a taught fit when in the unfolded or deployed position.

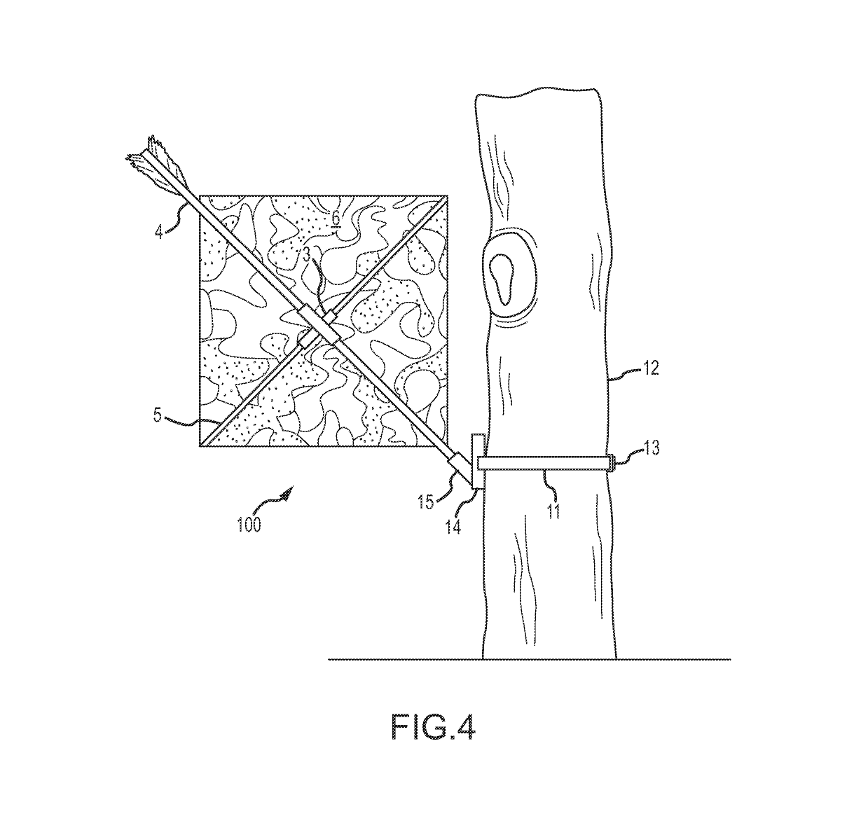

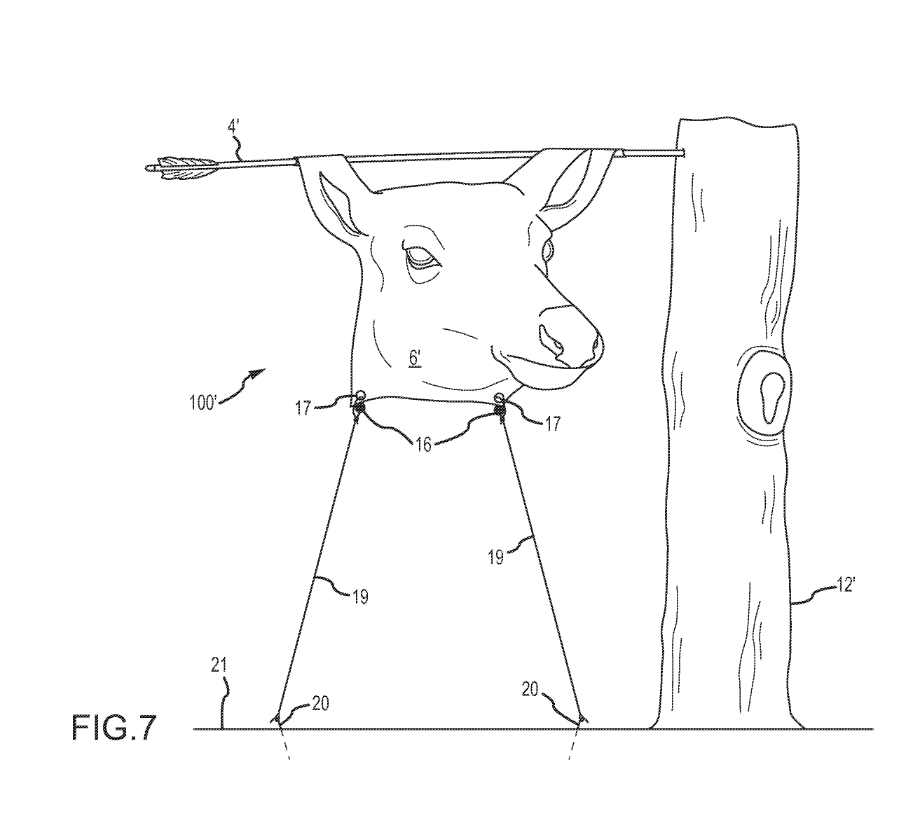

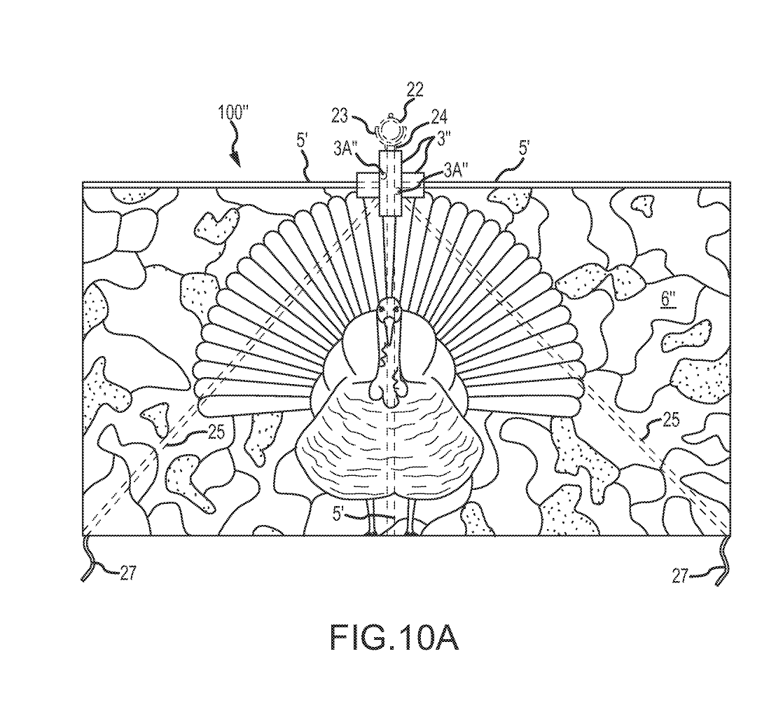

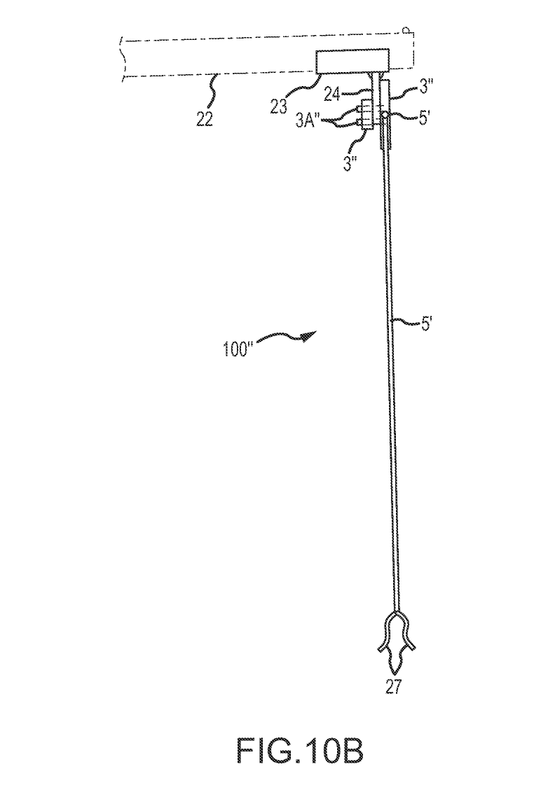

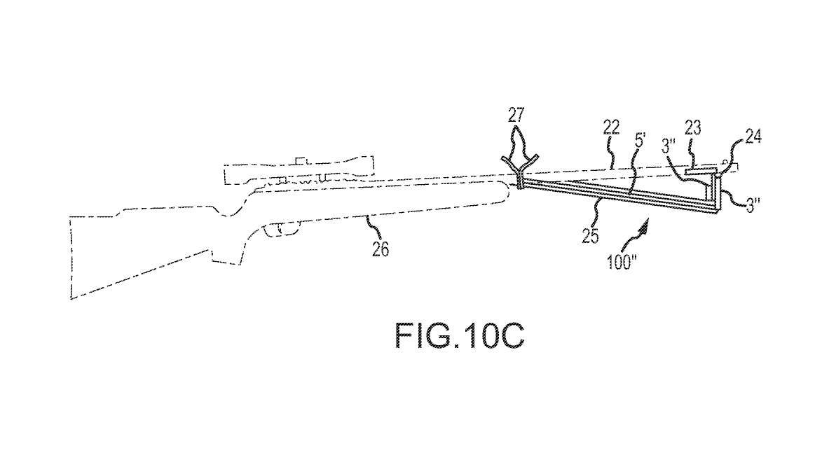

FIG. 4 shows an elevation view of an embodiment of an arrow mounted blind or decoy attached to a tree of the present invention. Referring now to FIG. 4, Arrow Mounted Blind Or Decoy 100 can be removed from Quiver 2 of Bow 1 and secured to Tree 12. Strap 11 is wrapped around a vertical structure, such as Tree 12, and is secured to Tree 12 by Buckle 13, which may be one of any type of securing mechanism, such as a buckle, cam buckle, ratchet buckle, or any other suitable adjustable securing device that secures Strap 11 to Tree 12. Attached to Strap 11 is Angle Bracket 14 which has Hollow Receiving Member 15 for receiving securely the tip of Arrow 4. Angle Bracket 14 may have a slot to receive Strap 11 there through, or any other attachment means. Hollow Receiving Member 15 is molded into or affixed to Angle Bracket 14 at an angle, typically around 45°, so that Arrow Mounted Blind Or Decoy 100 is aligned with Tree 12 as shown in FIG. 4. A hunter may stand behind Arrow Mounted Blind Or Decoy 100′ providing concealment, or, when Fabric 6 is a decoy, such as shown in FIGS. 7 and 10A, the hunter may stand off at a distance from Arrow Mounted Blind Or Decoy 100′.

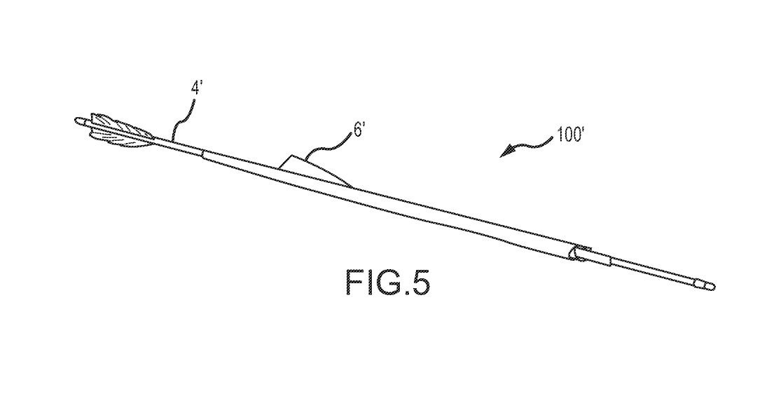

FIG. 5 shows a perspective view of another embodiment of an arrow mounted blind or decoy in a folded position of the present invention. Referring now to FIG. 5, Fabric 6′ is mounted directly to Arrow 4′ and is shown rolled up tightly around Arrow 4′. This makes Arrow Mounted Blind Or Decoy 100′ even more light-weight and portable.

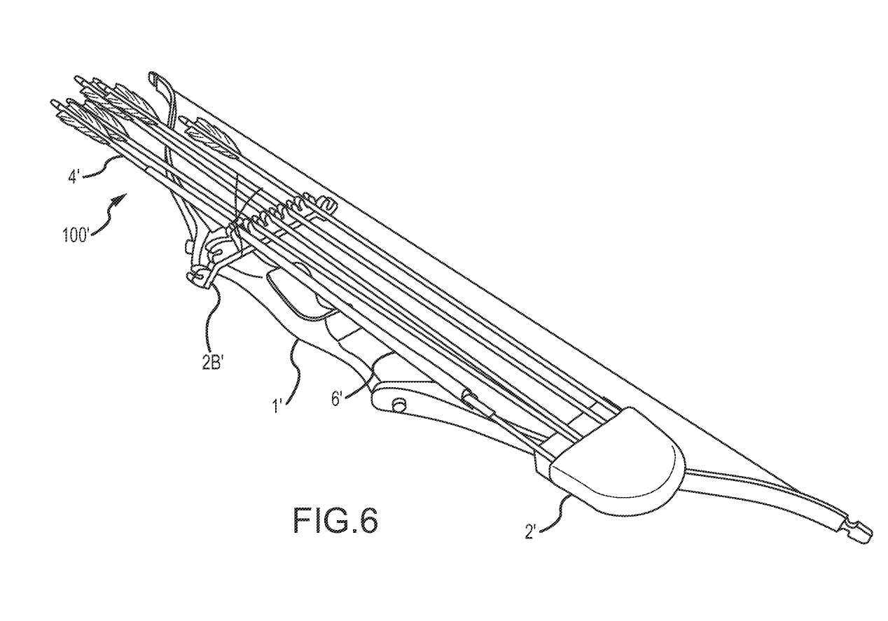

FIG. 6 shows a perspective view of an embodiment of an arrow mounted blind or decoy in a stowed position of the present invention. Referring now to FIG. 6, Arrow Mounted Blind Or Decoy 100′ has been stowed in Quiver 2′ and secured to Mounting Bracket 2B′ of Bow 1′. Arrow Mounted Blind Or Decoy 100′ does not take up much more space than a regular arrow.

FIG. 7 shows an elevation view of an embodiment of an arrow mounted blind or decoy attached to a tree of the present invention. Referring now to FIG. 7, Arrow Mounted Blind Or Decoy 100′ is shown deployed. The tip of Arrow 4′ has been shot or otherwise thrust into the side of a vertical structure, such as Tree 12′. Fabric 6′ is attached at a top edge to Arrow 4′ and is unfurled and allowed to hang down from Arrow 4′. The face of a deer is displayed on Fabric 6′ for this particular decoy in outline form. The decoy may depict that of any other game animal of interest, such as a bear, moose, elk, turkey, pheasant, quail, etc., in outline form, or with camouflage surrounding the outline form. In addition, Fabric 6′ may be square in shape with a camoflauge pattern such as that shown in FIG. 4 surrounding the face of the animal to the edges of the square. To help prevent Fabric 6′ from flapping in a breeze, Weights 16 may be attached to the bottom edges of Fabric 6′. Alternatively, elastic bands, string, Cord 19 may be secured at one end by large nails, spikes, or Stakes 20 driven into the Ground 21 approximately underneath the position of the Grommets 17, and secured at the other end to Grommets 17 in order to keep Fabric 6′ from flapping in a breeze. The hunter may now move freely in relation to Arrow Mounted Blind Or Decoy 100′ in order to gain a strategic position for shooting game.

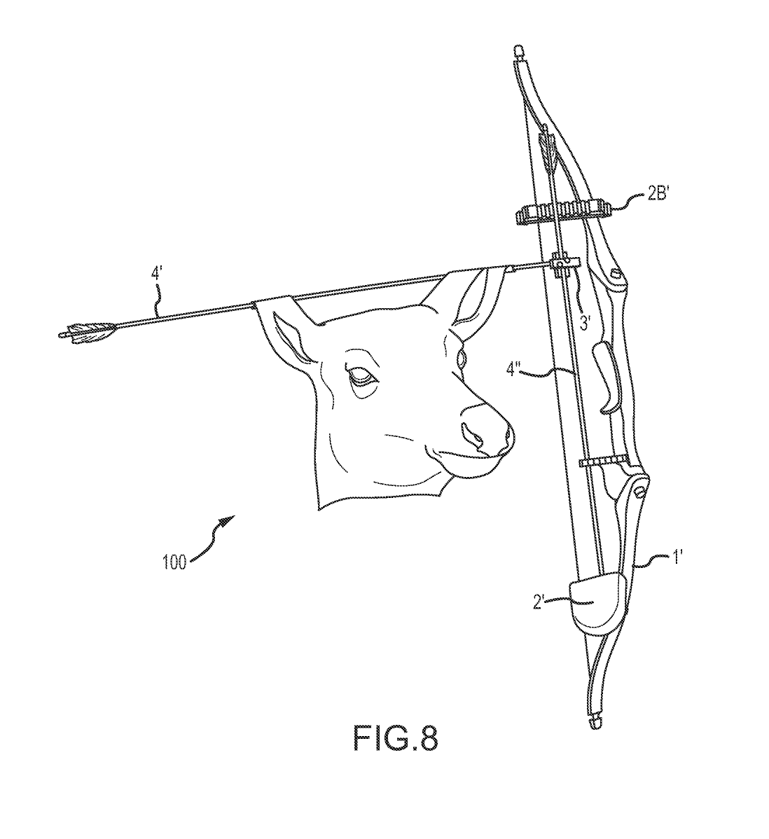

FIG. 8 shows a perspective view of an embodiment of an arrow mounted blind or decoy in a deployed position attached to a bow of the present invention. Referring now to FIG. 8, Arrow Mounted Blind Or Decoy 100′ has been secured to Bow 1′ by way of Mount 3′ similar to the embodiment shown in FIG. 1. Mount 3′ is affixed to Arrow 4′ and to Arrow 4″ which is secured to Quiver 2′ and Mounting Bracket 2B′.

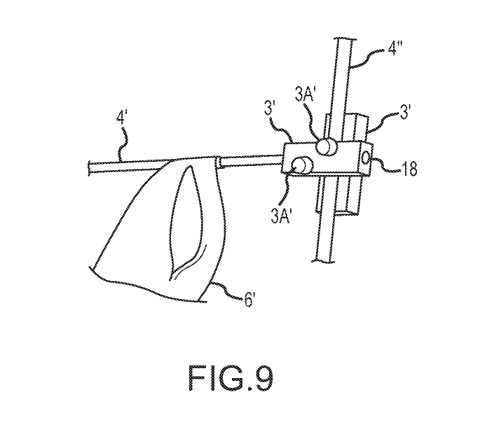

FIG. 9 shows a detailed view of an embodiment of an arrow mounted blind or decoy in a mount of the present invention. Referring now to FIG. 9, Mount 3′ is similar to Mount 3 shown in FIGS. 2A, 2B, and 2C. Arrow 4′ is secured between the two parts of Mount 3′ by Clamp Screws 3A′. The tip of Arrow 4′ is inserted securely into Hole 18 in one part of Mount 3′.

FIGS. 10A, 10B, and 10C show various views of another embodiment of a blind or decoy of the present invention. Referring now to FIGS. 10A, 10B, and 10C, Arrow Mounted Blind Or Decoy 100″ can be mounted to Barrel 22 of Gun 26 via Barrel Mount 23 and Attachment Rod 24. Gun 26 may be a rifle, a shotgun, or any other type of gun having a barrel. Barrel Mount 23 may be made of spring steel that has an inner radius that matches the outer radius of Barrel 22. Barrel Mount 23 is slightly larger (185° to 200°) than a semi-circle (180°) in cross-section such that it must be forced or snapped onto Barrel 22. The spring steel allows the longitudinal outer edges to flex outward and then snap back to their normal shape, thus gripping Barrel 22 securely. In addition, Barrel Mount 23 may also be magnetic, further insuring that Barrel Mount 23 will not easily move laterally along the length of Barrel 22 but will stay fixed at the point it was snapped onto Barrel 22. Alternatively, Barrel Mount 23 may be simply semi-circular (not requiring snapping onto Barrel 22) and simply highly magnetic. Or, Barrel Mount 23 may simply attach to Barrel 22 with screws or any other suitable attachment means. Attachment Rod 24 is welded, bolted, or otherwise fixedly attached to Barrel Mount 23 at approximately a ninety-degree angle. Attachment Rod 24 is clamped between the two halves of Mount 3″ with Clamp Screws 3A″.

Arrow Mounted Blind Or Decoy 100″ has Fabric 6″ with a decoy image of a turkey with camouflage surrounding the image, but could be any of the other type of decoys discussed above, and is shown in a deployed position in FIGS. 10A and 10B. Mount 3″ is similar in structure and function as that of Mount 3′. The two halves of Mount 3″ are clamped together with Clamp Screws 3A″. Spars 5′ from the folded position shown in FIG. 10C are inserted into Mount 3″ with Internal Shock Cord (not shown) running through Spars 5′ and Mount 3″ as described above. The vertical Spar 5′ may be an arrow. Fabric 6″ is attached along the lengths of each Spar 5′. To help prevent Fabric 6″ from flapping in a breeze, Stiffening Spars 25 are attached along their lengths to Fabric 6″ at approximately a forty-five degree angle from the horizontal, with a near end near the mount, but not inserted into the mount, and a far end extending to the edge of Fabric 6″. Though only two Stiffening Spars 25 are shown, more Stiffening Spars 25 may be added at other angles to provide greater stiffening. Stiffening Spars 25 may be made out of fiberglass or any other light-weight but strong material that are attached to Fabric 6″ by gluing, sewing, or any other suitable securing means. Fabric 6″ in the folded position will fold and buckle similar to the fabric of a folded umbrella. Ties 27 are attached to ends of Stiffening Spars 25 and can be used to secure Fabric 6″ and the ends of the Spars 5′ to Barrel 22 of Gun 26 in the folded position as shown in FIG. 10C (Fabric 6″ not shown in this view).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It will be understood by those skilled in the art that many changes in construction and widely differing embodiments and applications will suggest themselves without departing from the scope of the disclosed subject matter.

What is claimed is:

1. An apparatus for concealment comprising:
a rod having a tip;
a mount adapted to be attached to the rod;
a plurality of spars inserted into the mount to secure a deployed position of the apparatus;
at least one internal shock cord for securing the plurality of spars to the mount in the deployed position, the at least one internal shock cord running internally through the plurality of spars and internally through the mount;
a fabric attached to the outer ends of the plurality of spars in the deployed position;
a strap having a securing mechanism that is used to secure the strap around a vertical structure; and
an angle bracket attached to the strap and having a hollow receiving member that receives the tip of the rod;
wherein the apparatus in the deployed position is fixed proximate to the vertical structure to provide concealment.

2. The apparatus according to claim 1 wherein the rod is an arrow.

3. The apparatus according to claim 1 wherein the fabric further comprises:
at least one of a camouflage pattern in at least one color, and a decoy depicting a game animal.

4. The apparatus according to claim 1 wherein the plurality of spars further comprise:
a first spar;
a second spar;
a third spar;
a fourth spar, wherein each spar has an outer end and an inner end, and further wherein each inner end is inserted into the mount in the deployed position; and
a spar clamp;
wherein in a folded position of the apparatus, the inner ends of the plurality of spars are removed from the mount and the outer ends of the plurality of spars are folded and secured to each other and to the rod with the spar clamp.

5. The apparatus according to claim 1 wherein the apparatus in a folded position is stored in a quiver of a bow.

6. The apparatus according to claim 1 wherein the mount further comprises:
a first half;
a second half;
a channel between the first half and the second half; and
at least one clamp screw;
wherein the rod is received in the channel and secured between the first half and the second half of the mount by tightening the at least one clamp screw.

7. A method for concealment using an apparatus, the method comprising the steps of:
(a) attaching a mount to a rod;
(b) inserting a plurality of spars into the mount, securing a deployed position of the apparatus;
(c) securing the plurality of spars to the mount with at least one internal shock cord that runs internally through the plurality of spars and internally through the mount;
(d) attaching a fabric to the outer ends of the plurality of spars in the deployed position of the apparatus;
(e) securing a strap around a vertical structure with a securing mechanism; and
(f) receiving the tip of the rod in a hollow receiving member of an angle bracket attached to the strap;
wherein the apparatus in the deployed position is fixed proximate to the vertical structure for providing concealment.

8. The method for concealment using an apparatus according to claim 7 further comprising the step of:
attaching the mount to an arrow instead of a rod.

9. The method for concealment using an apparatus according to claim 7 further comprising the step of:
fashioning the fabric to have at least one of a camouflage pattern having at least one color, and a decoy depicting a game animal.

10. The method for concealment using an apparatus according to claim 7 wherein step (c) further comprises the steps of:
inserting an inner end of a first spar into the mount;
inserting an inner end of a second spar into the mount;
inserting an inner end of a third spar into the mount; and
inserting an inner end of a fourth spar into the mount, securing the deployed position of the apparatus.

11. The method for concealment using an apparatus according to claim 10 further comprising the steps of:
removing the inner ends of the plurality of spars from the mount;
folding the plurality of spars together in a folded position;
clamping with a spar clamp the outer ends of the plurality of spars to the rod; and
storing the apparatus in the folded position in a quiver of a bow.

12. The method for concealment using an apparatus according to claim 7 further comprising the steps of:
boring a channel between a first half and a second half of the mount;
receiving the rod in the channel between the first half and a second half of the mount; and
tightening at least one clamp screw to secure the rod in the channel between the first half and the second half of the mount.

13. An apparatus for concealment comprising:
an arrow having a tip; and
a fabric attached at a top edge to the arrow which hangs down from the arrow in an unfurled position;
wherein the tip of the arrow is driven into a vertical structure and the in the unfurled position is fixed proximate to the vertical structure to provide concealment.

14. The apparatus for concealment according to claim 13 wherein the fabric further comprises:
at least one of a camouflage pattern in at least one color, and a decoy depicting a game animal.

15. The apparatus for concealment according to claim 13 further comprising:
a one or more weights attached to a bottom edge of the fabric;
wherein the one or more weights help prevent the fabric from flapping in a breeze.

16. The apparatus for concealment according to claim 13 further comprising:
a one or more grommets located in a bottom edge of the fabric;
a one or more stakes driven into the ground approximately underneath the position of the grommets; and
a one or more cords secured to the one or more grommets at one end and secured to the one or more stakes at the other end;
wherein the one or more grommets, stakes, and cords help prevent the fabric from flapping in a breeze.

17. The apparatus for concealment according to claim 13 wherein the apparatus in a furled position is stored in a quiver of a bow.

18. The apparatus for concealment according to claim 13 further comprising:
a second arrow fixed in a quiver of a bow;
a mount adapted to be attached to the second arrow; and
a hole in the mount which receives securely the tip of the arrow;
wherein in the unfurled position, the apparatus is fixed proximate to the bow to provide concealment.

19. The apparatus for concealment according to claim 13 wherein the mount further comprises:
a first half;
a second half;
a channel between the first half and the second half; and
at least one clamp screw;
wherein the second arrow is received in the channel and secured between the first half and the second half of the mount by tightening the at least one clamp screw.

20. A method for concealment using an apparatus, the method comprising the steps of:
(a) attaching a fabric to a top edge of an arrow having a tip, wherein the fabric hangs down from the arrow in an unfurled position;
(b) driving the tip of the arrow into a vertical structure; and
(c) providing concealment through the apparatus in the unfurled position fixed proximate to the vertical structure.

21. The method for concealment using an apparatus according to claim 20 further comprising the step of:
fashioning the fabric to have at least one of a camouflage pattern having at least one color, and a decoy depicting a game animal.

22. The method for concealment using an apparatus according to claim 20 further comprising the step of:
attaching one or more weights to a bottom edge of the fabric;
wherein the one or more weights help prevent the fabric from flapping in a breeze.

23. The method for concealment using an apparatus according to claim 20 further comprising the steps of:
locating a one or more grommets in a bottom edge of the fabric;
driving a one or more stakes into the ground approximately underneath the position of the grommets; and
securing a one or more cords to the one or more grommets at one end and to the one or more stakes at the other end;
wherein the one or more grommets, stakes, and cords help prevent the fabric from flapping in a breeze.

24. The method for concealment using an apparatus according to claim 20 further comprising the steps of:
furling the fabric around the arrow; and
storing the arrow in a quiver of a bow.

25. The method for concealment using an apparatus according to claim 20 further comprising the steps of:
fixing a second arrow in a quiver of a bow;
attaching a mount to the second arrow;
receiving the tip of the arrow securely in a hole in the mount; and
providing concealment through the apparatus in the unfurled position fixed proximate to the bow.

26. The method for concealment using an apparatus according to claim 20 further comprising the steps of:
forming a channel between a first half and a second half of the mount;
receiving the second arrow in the channel between the first half and the second half of the mount; and
tightening at least one clamp screw and thereby clamping the first half and the second half of the mount together, thereby securing the second arrow in the channel.

27. An apparatus for concealment comprising:
a barrel mount having an attachment rod adapted to be attached to a barrel of a gun;
a mount adapted to be attached to the attachment rod;
a plurality of spars inserted into the mount to secure a deployed position of the apparatus;
at least one internal shock cord for securing the plurality of spars to the mount in the deployed position, the at least one internal shock cord running internally through the plurality of spars and internally through the mount; and
a fabric attached to the plurality of spars along their lengths in the deployed position;
wherein the apparatus in the deployed position is fixed proximate to the gun to provide concealment.

28. The apparatus for concealment according to claim 27 wherein the fabric further comprises:
at least one of a camouflage pattern in at least one color, and a decoy depicting a game animal.

29. The apparatus for concealment according to claim 27 wherein the plurality of spars further comprise:
a first spar;
a second spar;
a third spar, wherein each spar has an outer end and an inner end, and further wherein each inner end is inserted into the mount in the deployed position; and
one or more stiffening spars attached to the fabric along their lengths that extend from a near end near the mount to the edge of the fabric at a far end;
wherein in a folded position of the apparatus, the inner ends of the plurality of spars are removed from the mount and the outer ends of the plurality of spars are folded and secured to each other and to the one or more stiffening spars and to the barrel of the gun with one or more ties located at the far ends of the one or more stiffening spars.

30. The apparatus for concealment according to claim 27 wherein the mount further comprises:
a first half;
a second half;
a channel between the first half and the second half; and
at least one clamp screw;
wherein the attachment rod is received in the channel and secured between the first half and the second half of the mount by tightening the at least one clamp screw.

31. The apparatus for concealment according to claim 27 wherein the barrel mount further comprises:
a cross-section that is equal to or slightly larger than semi-circular;
an inner radius that matches the outer radius of the barrel; and
a magnetic property;
wherein the barrel mount is snapped in place over the barrel and further held in place due to the magnetic property of the barrel mount, and further wherein the attachment rod is fixedly attached to the barrel mount at approximately a ninety-degree angle.

32. A method for concealment using an apparatus, the method comprising the steps of:
(a) attaching a barrel mount having an attachment rod to a barrel of a gun;
(b) attaching a mount to the attachment rod;
(c) inserting a plurality of spars into the mount, securing a deployed position of the apparatus;
(d) securing the plurality of spars to the mount with at least one internal shock cord that runs internally through the plurality of spars and internally through the mount; and
(e) attaching a fabric to the plurality of spars along their lengths in the deployed position of the apparatus;
wherein the apparatus in the deployed position is fixed proximate to the gun for providing concealment.

33. The method for concealment using an apparatus according to claim 32 further comprising the step of:
fashioning the fabric to have at least one of a camouflage pattern having at least one color, and a decoy depicting a game animal.

34. The method for concealment using an apparatus according to claim 32 wherein step (d) further comprises the steps of:
inserting an inner end of a first spar into the mount;
inserting an inner end of a second spar into the mount; and
inserting an inner end of a third spar into the mount, securing the deployed position of the apparatus.

35. The method for concealment using an apparatus according to claim 34 further comprising the step of:
attaching one or more stiffening spars to the fabric along their lengths that extend from a near end near the mount to the edge of the fabric at a far end.

36. The method for concealment using an apparatus according to claim 35 further comprising the steps of:
removing the inner ends of the plurality of spars from the mount;
folding the plurality of spars and the one or more stiffening spars together;
securing with one or more ties located at the far ends of the one or more stiffening spars the outer ends of the plurality of spars to the barrel of the gun in a folded position.

37. The method for concealment using an apparatus according to claim 32 further comprising the steps of:
boring a channel between a first half and a second half of the mount;
receiving the attachment rod in the channel between the first half and a second half of the mount; and
tightening at least one clamp screw to secure the attachment rod in the channel between the first half and the second half of the mount.
